(19) United States
(12) Patent Application Publication
(10) Pub. No.: US 2014/0229901 A1
(43) Pub. Date: Aug. 14, 2014

(54) Interactive Treemap User Interface

(71) Applicant: SAP AG, Walldorf (DE)

(72) Inventors: Ruchi Kumar Chand, Palo Alto, CA (US); Long Cheng, Palo Alto, CA (US); Boqing Xue, Palo Alto, CA (US); Anna Blumovitz, Palo Alto, CA (US); Sivagami Sabaretnam, Palo Alto, CA (US); Andrea Anderson, Palo Alto, CA (US); Michael Ellard, Palo Alto, CA (US)

(73) Assignee: SAP AG, Walldorf (DE)

(21) Appl. No.: 13/767,785

(22) Filed: Feb. 14, 2013

(51) Int. Cl. G06F 3/0482

(52) U.S. Cl. CPC G06F 3/0482
USPC 715/854

(57) ABSTRACT

Database information may be accessed through a user interface comprising one or more interactive treemaps. Each interactive treemap reflects a hierarchical structure of the stored information, for example parent and child nodes. By providing one type of input (e.g., a reverse finger pinch) to a sub-area of the treemap, the user may cause a different treemap to be displayed reflecting the hierarchical structure (grandchild nodes) of the sub-area. A treemap may also be manipulated by a user to provide additional detail. For example, by providing another type of input (e.g., a finger tap) to a treemap sub-area, a user may cause further information relevant to a child node to be displayed as a pop-up or as a separate detail screen. The treemap views of the interface provide a user with fluid and intuitive navigation upward/downward through the hierarchy, with detail screens allowing access to additional stored database information as desired.

### BACKGROUND

Embodiments of the present invention relate to a user interface, and in particular, to a user interface in the form of an interactive treemap.

Unless otherwise indicated herein, the approaches described in this section are not prior art to the claims in this application and are not admitted to be prior art by inclusion in this section.

A treemap is a way of visualizing information for a hierarchical structure by using two-dimensional areas and color coding. A treemap may help a user to quickly spot patterns and exceptions. In particular, a treemap may afford a user with a visual sense of the hierarchy, by presenting child information as areas of different sizes within an overall area representing the parent information.

While conventional treemaps are useful in communicating information regarding a hierarchy, their ability to display a variety of information can be limited. In particular, when displaying a treemap on a user interface, the consumption of screen area by the interface to display a single dimension of hierarchical information may interfere with the interface's ability to communicate other types of relevant information that may be of value to a user.

Accordingly, the present disclosure addresses these and other issues with a user interface featuring an interactive treemap.

### SUMMARY

Database information may be accessed through a user interface comprising one or more interactive treemaps. Each interactive treemap reflects a hierarchical structure of the stored information, for example parent and child nodes. By providing one type of input (e.g., a reverse finger pinch) to a sub-area of the treemap, the user may cause a different treemap to be displayed reflecting the hierarchical structure (e.g., grandchild nodes) of the sub-area. A treemap may also be manipulated by a user to provide additional detail. For example, by providing another type of input (e.g., a finger tap) to a treemap sub-area, a user may cause further information relevant to a child node to be displayed as a pop-up or as a separate detail screen or window. The treemap views of the interface provide a user with fluid and intuitive navigation upward/downward through the hierarchy, with detail screens allowing access to additional stored database information as desired.

An embodiment of a computer-implemented method comprises providing database storing information according to a hierarchy comprising a parent node and a child node. An interface engine is caused to display a first interactive treemap comprising a first overall area representing the parent node and comprising the child node as a first sub-area of the first overall area. The interface engine is caused to receive user input. In response to the user input, the interface engine is caused to display a detail of the child node or of the parent node.

An embodiment of a non-transitory computer readable storage medium embodies a computer program for performing a method. The method comprises providing database storing information according to a hierarchy comprising a parent node and a child node. An interface engine is caused to display a first interactive treemap comprising a first overall area representing the parent node and comprising the child node as a first sub-area of the first overall area. The interface engine is caused to receive user input. In response to the user input, the interface engine is caused to display a detail of the child node or of the parent node.

An embodiment of a computer system comprises one or more processors and a software program executable on said computer system. The software program is configured to provide database storing information according to a hierarchy comprising a parent node and a child node. The software program is further configured to cause an interface engine to display a first interactive treemap comprising a first overall area representing the parent node and comprising the child node as a first sub-area of the first overall area. The software program is further configured to cause the interface engine to receive user input. In response to the user input, the software program is further configured to cause the interface engine to display a detail of the child node or of the parent node.

According to some embodiments, the interface engine is caused to display the detail as a pop-over of the treemap.

In certain embodiments, the interface engine is caused to display the detail as a separate detail screen.

In particular embodiments, the interface is caused to display the detail as a second interactive treemap comprising a second overall area representing the child node and comprising a grandchild node of the hierarchy as a sub-area of the second overall area.

According to various embodiments, the first interactive treemap is displayed on a touchscreen and the user input comprises touching the touch screen.

In some embodiments the interface engine is located in a user device.

In certain embodiments the interface engine is located remote from a user device.

The following detailed description and accompanying drawings provide a better understanding of the nature and advantages of particular embodiments.

### BRIEF DESCRIPTION OF THE DRAWINGS

FIGS. 1A-D show views presenting various aspects of a user interface according to an embodiment.

FIG. 1AA show a generic view of information stored in a database according to a hierarchy.

FIG. 2 shows a simplified view of a system configured to present a user interface according to an embodiment.

FIGS. 3-3B3 show screen shots of a specific example of a user interface according to an embodiment.

FIG. 4 illustrates hardware of a special purpose computing machine configured to provide a user interface according to an embodiment.

FIG. 5 illustrates an example of a computer system.

FIG. 6 presents a simplified flow diagram of a method according to an embodiment.

### DETAILED DESCRIPTION

Described herein are techniques for providing a user interface. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

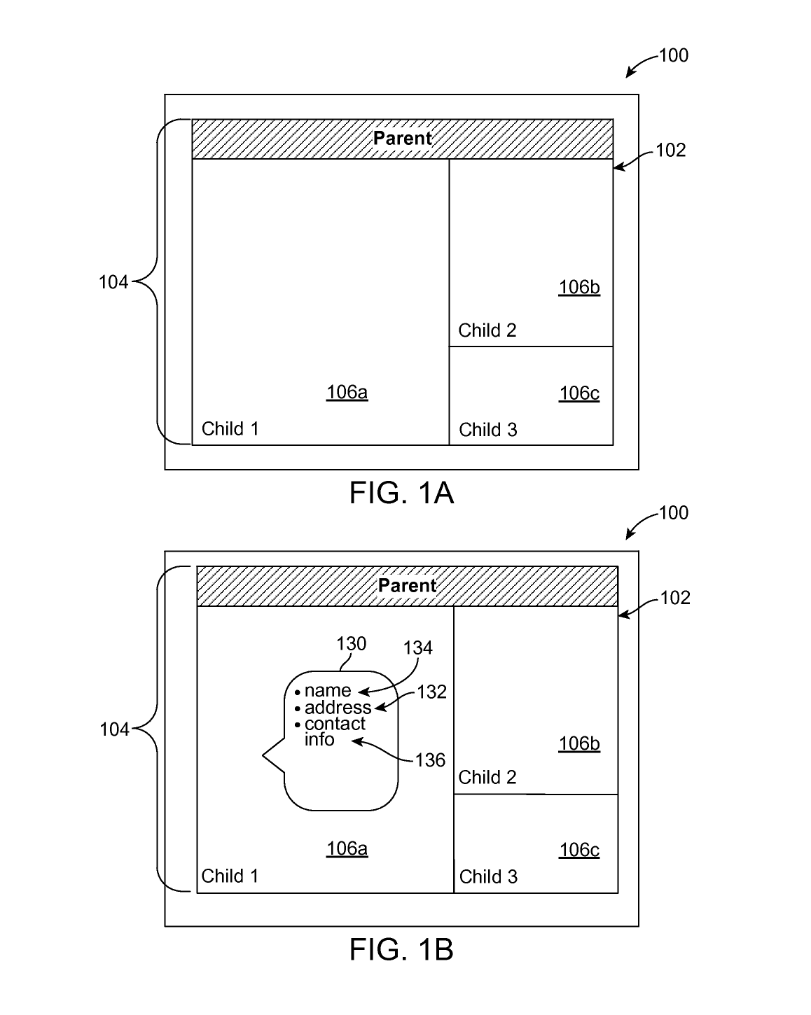

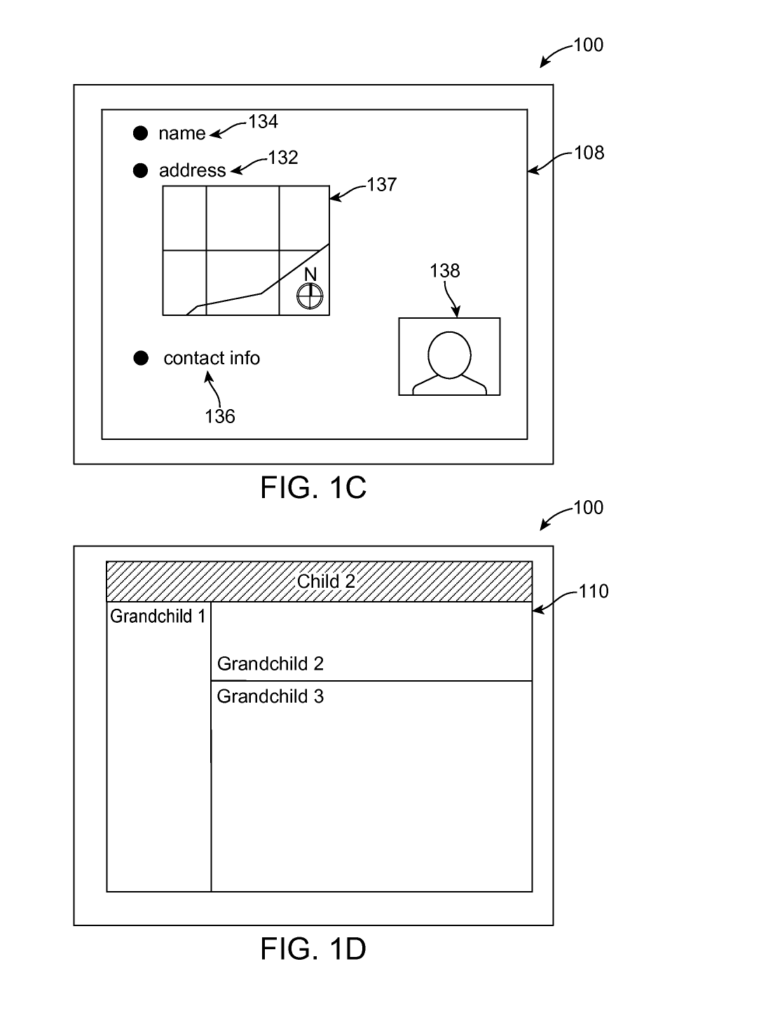

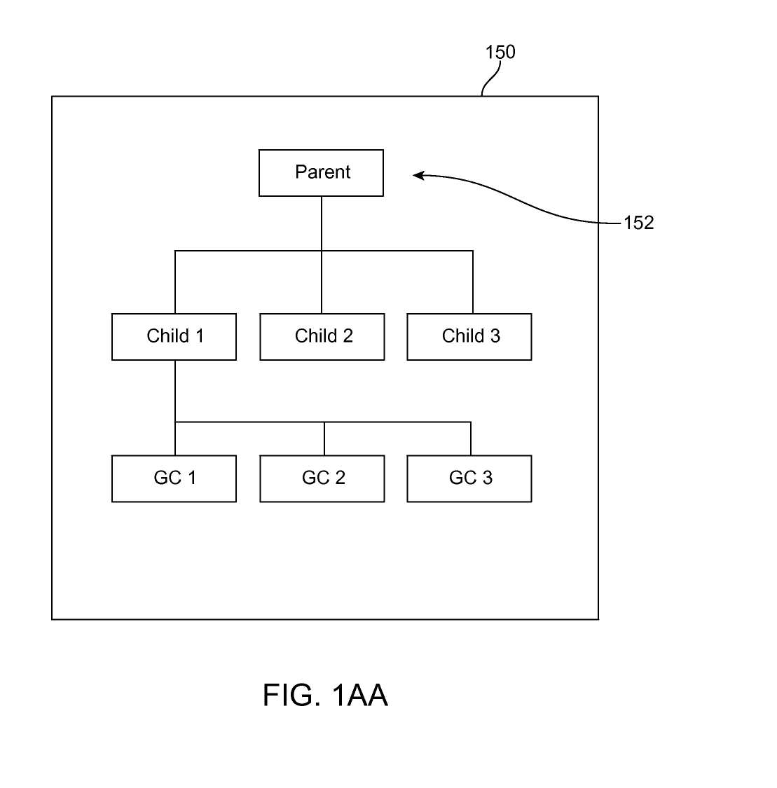

FIG. 1A shows a view of a user interface 100 featuring an interactive treemap 102 according to an embodiment. Treemap 102 may present a visual representation of the relationship between certain elements organized according to a hierarchical relationship. In particular, treemap 102 may comprise an overall area 104 reflecting a parent node, which includes within it a plurality of sub-areas 106a-c reflecting different child nodes of the parent node.

FIG. 1AA is a simplified view of a database 150 or other data storage structure comprising information stored according to a hierarchy 152, and which is accessed through the user interface. Here, the hierarchy 152 comprises a parent node having child nodes 1-3. The child node 1 itself further comprises three grandchild (GC) nodes 1-3.

Returning to FIG. 1A, the treemap 102 is organized based upon a first dimension of information that is shared between the parent node and the children. For example, the overall area reflects a total quantity of the first dimension possessed by the parent, whereas the sub-area of each child node reflects a relative quantity of that dimension possessed by that child node.

To further illustrate this concept, the treemap 102 may depict the dimension of population within a business hierarchy. Thus, the area of the parent node may reflect an overall census, while the size of the sub-areas 106a-c nested within the larger area may reflect the relative population of various business departments.

As mentioned above, an interface according to embodiments features a treemap that is interactive. Such a treemap may be manipulated by a user to display additional information, including information reflecting a different hierarchical dimension than the original treemap.

For example, FIG. 1B shows that upon a user providing input in the form of tapping a particular sub-area, additional details regarding a child node may be displayed. Specifically, upon tapping the sub-area 106a, a pop-over 130 is displayed that conveys additional information. For example, the pop-over 130 may indicate information such as an address 132 of the particular department, the name 134 of the head of that particular department, and the contact information 136 of that particular department.

FIG. 1C shows that upon further manipulation of the pop-up 130, the additional information may be displayed in more detail in a separate detail screen. Here, for example, a map 137 of the location of the department, and a photograph 138 of the department head, may be displayed in addition to the address 132, name 134 and contact information 136.

In addition to providing additional details, a treemap of an interface according to an embodiment may be interactive in that the interface allows a user to obtain further information in the hierarchical dimension being displayed. For example, FIG. 1D shows that upon a user providing an input in the form of finger-pinching a particular sub-area, a second interactive treemap may be displayed revealing the hierarchical structure of the child node.

Thus in FIG. 1D, pinching the sub-area 106a of FIG. 1A, reveals a screen with a different treemap 110 having an overall area dedicated to that child node, with sub-areas representing grandchild nodes. This could be useful, for example, to show the department census broken down according to department headcount by geographic region.

Through the application of an appropriate input (e.g., tapping, finger pinching, voice, keystroke etc.) the user can navigate through the various treemap screens and detail screens to gather appropriate information from the stored database.

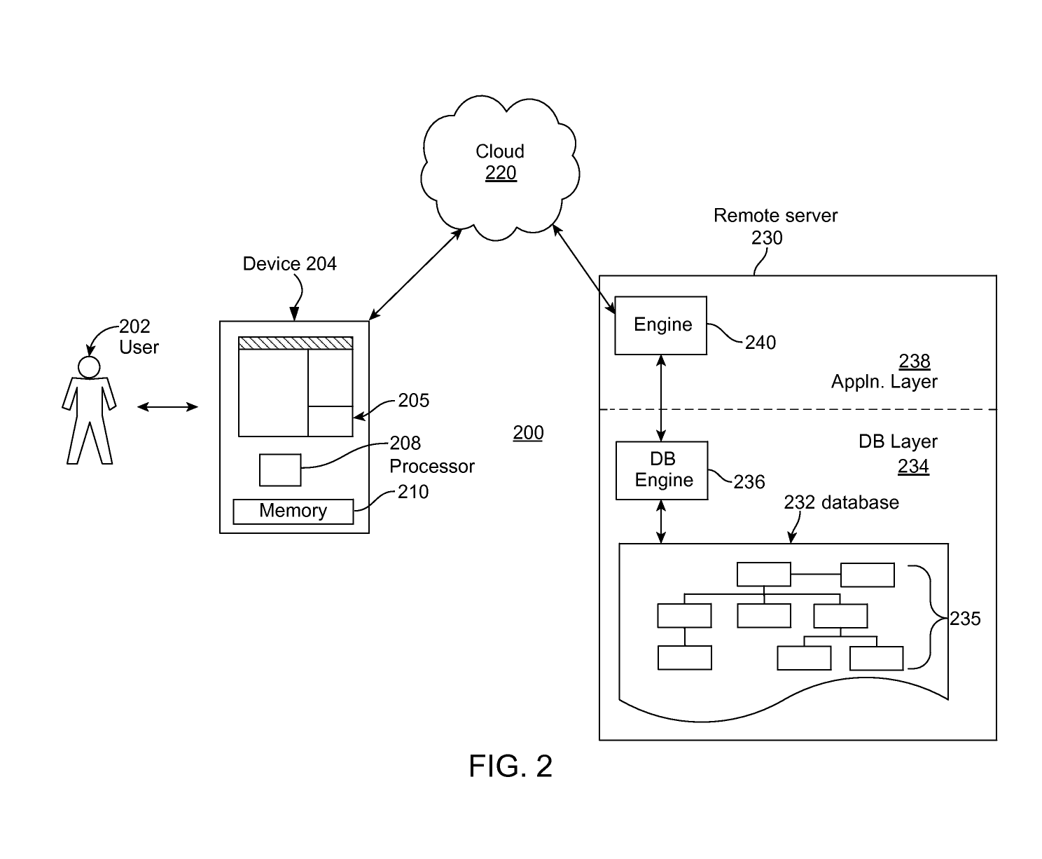

FIG. 2 shows a simplified view of a system that is configured to provide a user interface according to an embodiment. Specifically, system 200 comprises user 202 in communication with a user device 204.

In certain embodiments, the user device may be portable in nature, for example comprising a mobile device such as a smartphone, tablet, or laptop computer. In other embodiments, the user device could comprise a desktop computer or workstation.

The user device 204 may comprise input/output element 205, for example a touchscreen. Alternatively, separate input/output elements (e.g., keyboard and screen) could be employed. The user device may include a processor 208 that is configured to receive inputs, and to provide outputs. The processor may be in communication with a non-transitory computer-readable storage medium 210 having code stored thereon.

In certain embodiments, the processor of the user device may comprise an interface engine that is configured to generate the user interface including the interactive treemap, and to receive user input thereto. In other embodiments, the processor of the user device may have less functionality, and may simply be configured to display output and receive input according to instructions received from an interface engine located remotely.

The user device 204 may be in communication with a remote server 230 through communications network 220. At least some part of communications network 220 may be wireless in nature.

The remote server 230 may host a database 232 located within a database layer 234. The database 232 may store information organized according to a hierarchy 235. Access to the database 232 from outside the database layer 234, is governed by database engine 236.

In some embodiments, the database 232 may comprise a conventional disk based database. According to some embodiments, the database 232 may comprise an in-memory database. One example of such an in memory database is the HANA database available from SAP AG of Walldorf, Germany. Other examples of in-memory databases can include, but are not limited to, the SYBASE IQ database also available from SAP AG, the Microsoft Embedded SQL for C (ESQL/C) database available from Microsoft Corp. of Redmond, Wash., and the Exalytics In-Memory database available from Oracle Corp. of Redwood Shores, Calif. In certain embodiments (e.g., where the database comprises an in-memory database), the database engine 236 could also function as the interface engine.

As indicated above, in certain embodiments, the remote server 230 may also host an application layer 238 that includes an interface engine 240. The interface engine 240 is configured to interact with the database 232 via the database engine 236, in order to extract and display information of the database 232 relevant to user input to the interface. Thus the interface engine 240 may be configured to receive various user commands, and in response thereto create different views (e.g., treemap, pop-up, detail) including database information relevant thereto.

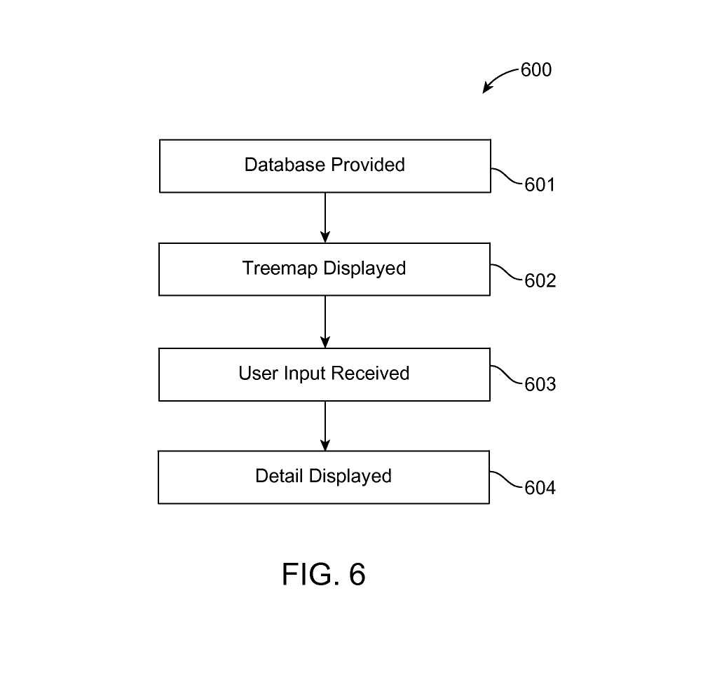

FIG. 6 shows a simplified flow chart of method 600 according to an embodiment. In a first step 601, a database is provided storing information according to a hierarchy comprising a parent node and a child node. In a second step 602, an interface engine is caused to display a first interactive treemap comprising a first overall area representing the parent node, and comprising the child node as a first sub-area of the first overall area. In a third step 603, the interface engine is caused to receive a user input. In a fourth step 604, in response to the user input, causing the interface engine is caused to display a detail of the child node.

Additional details regarding the structure and operation of various embodiments, may be understood from the specific example that is presented below.

### Example

An interface according to an embodiment, may be particularly useful in displaying financial information relevant to various entities present within a hierarchical organization. Specifically, the RealSpend™ software available from SAP AG of Walldorf, Germany, allows a user to track spending according to various dimensions, within a large organization.

Thus in an embodiment, an interactive treemap interface offers a RealSpend™ user the ability to readily visualize such spend information according to various different dimensions. Examples of such dimensions include but are not limited to: spending by department, spending by project, spending by product, and spending by category.

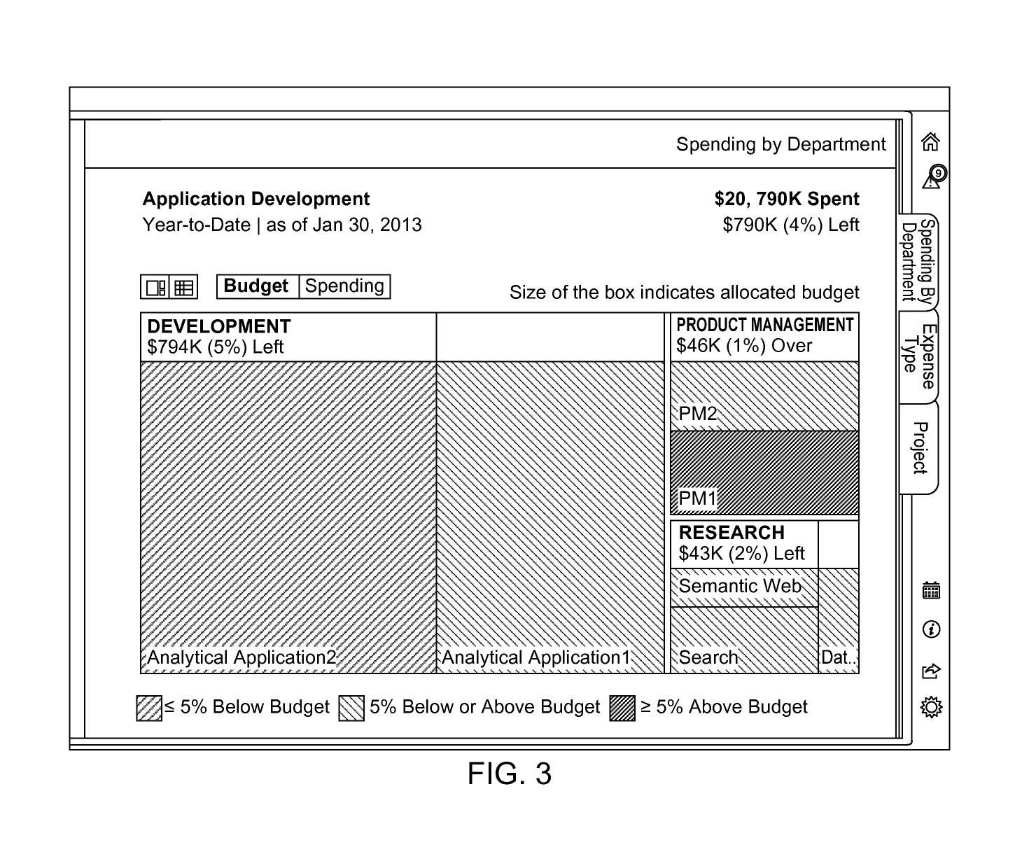

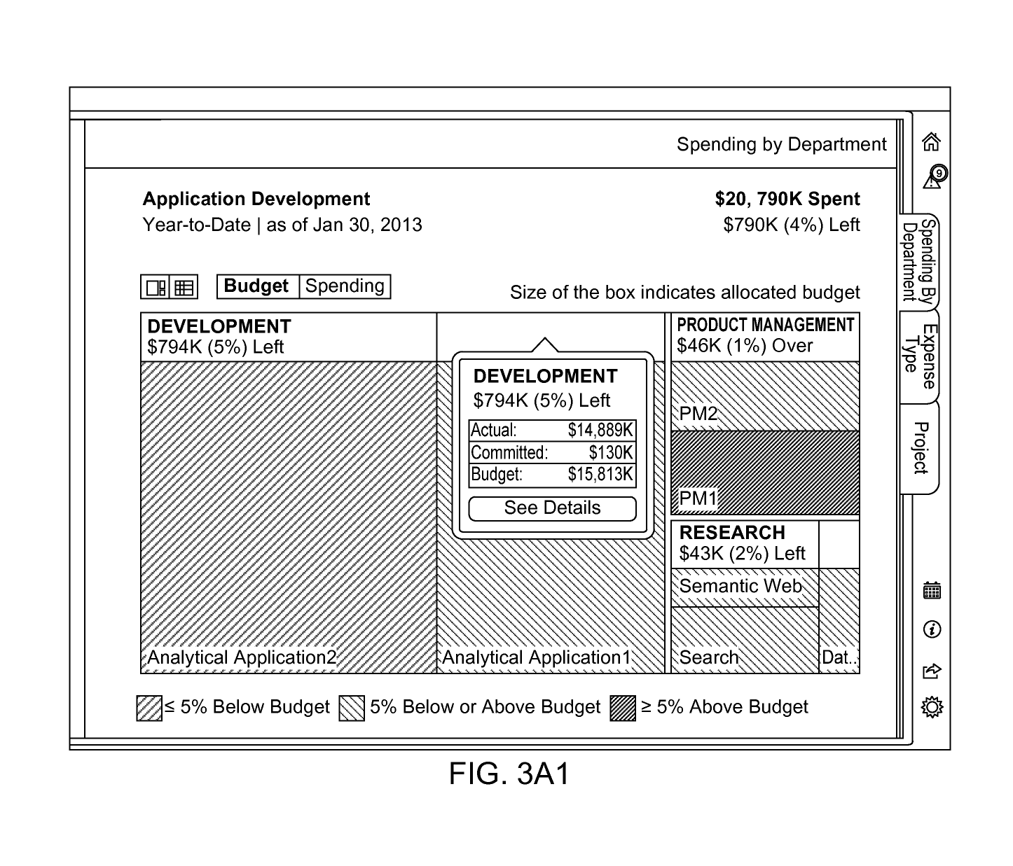

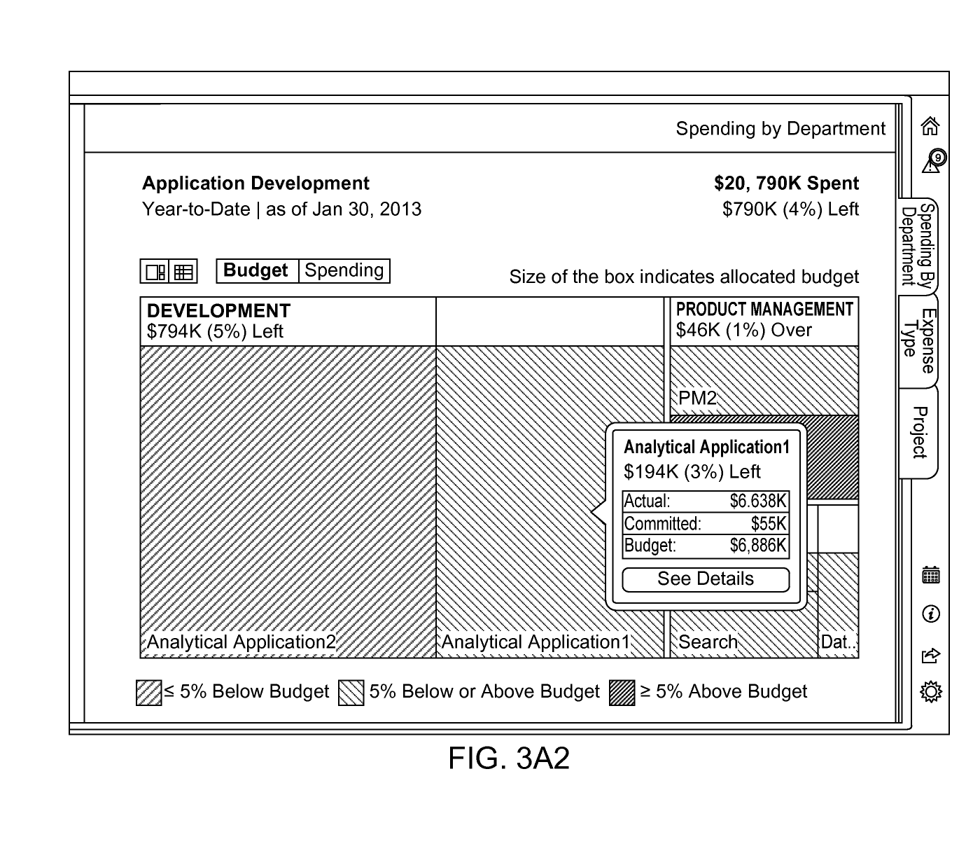

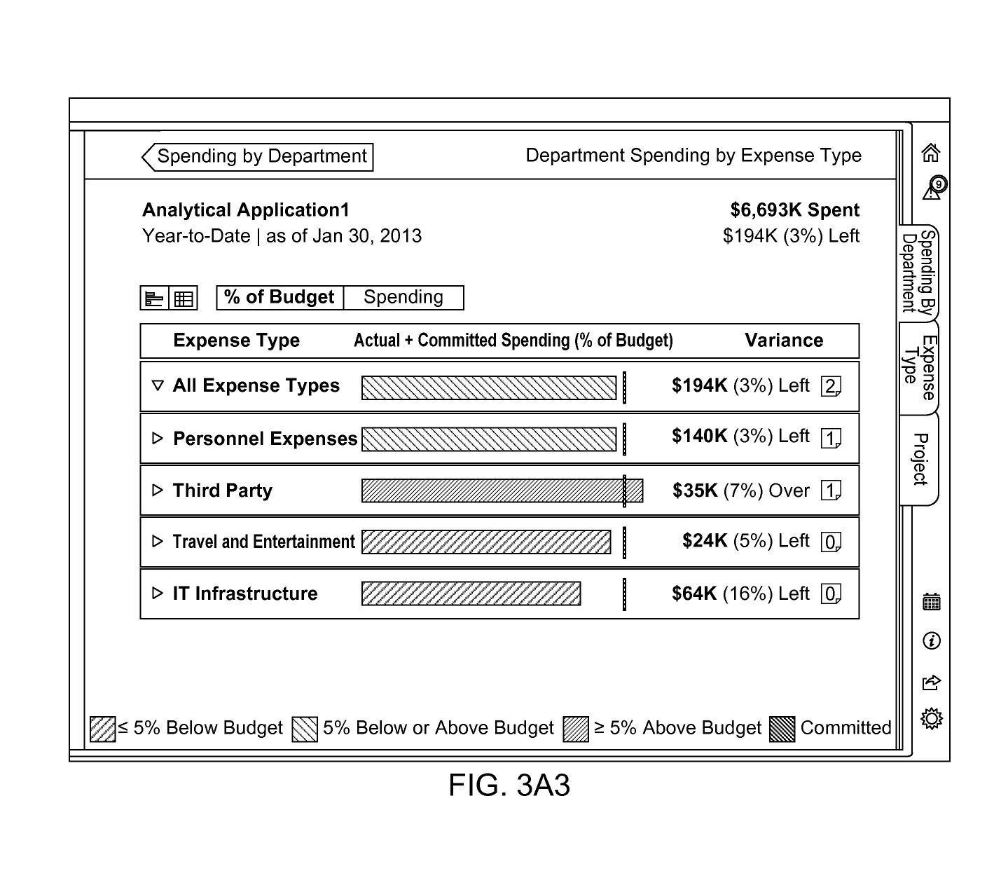

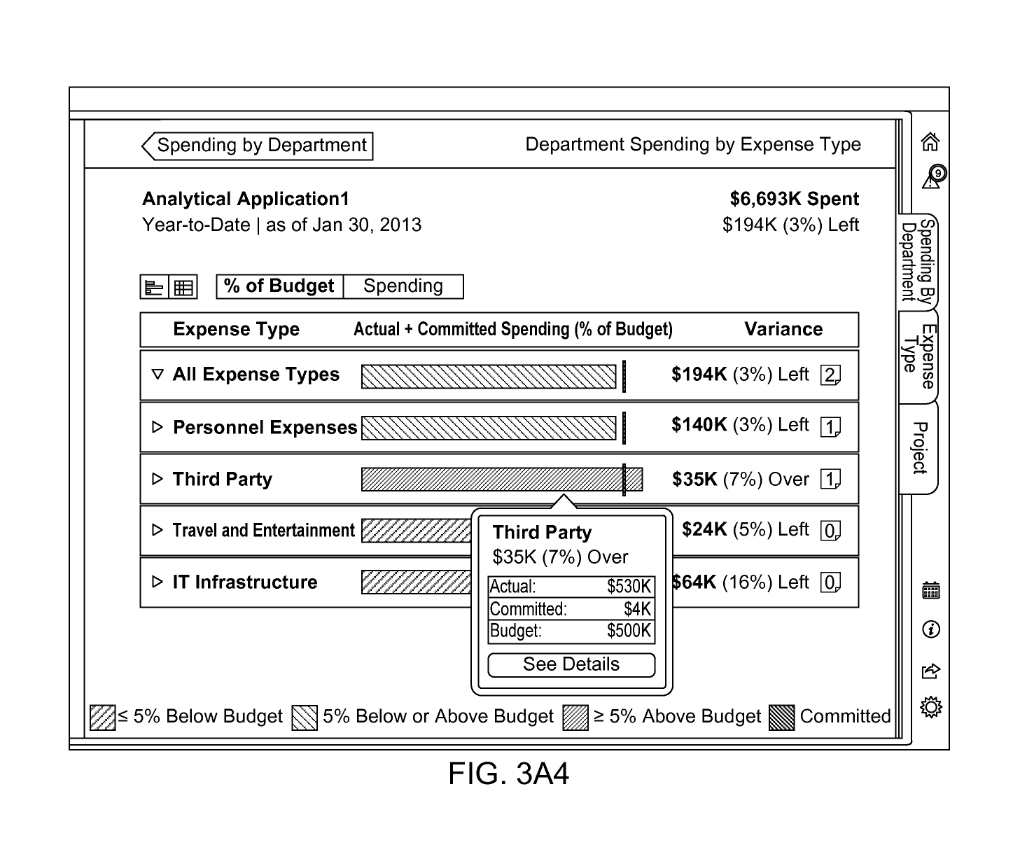

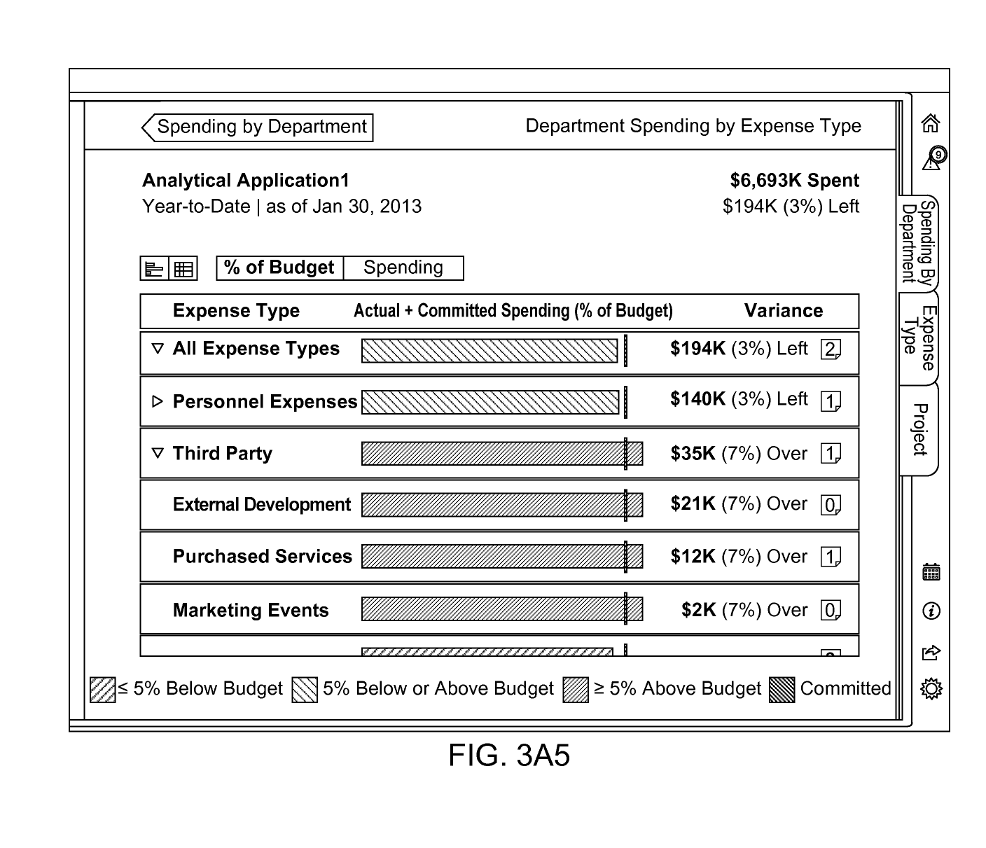

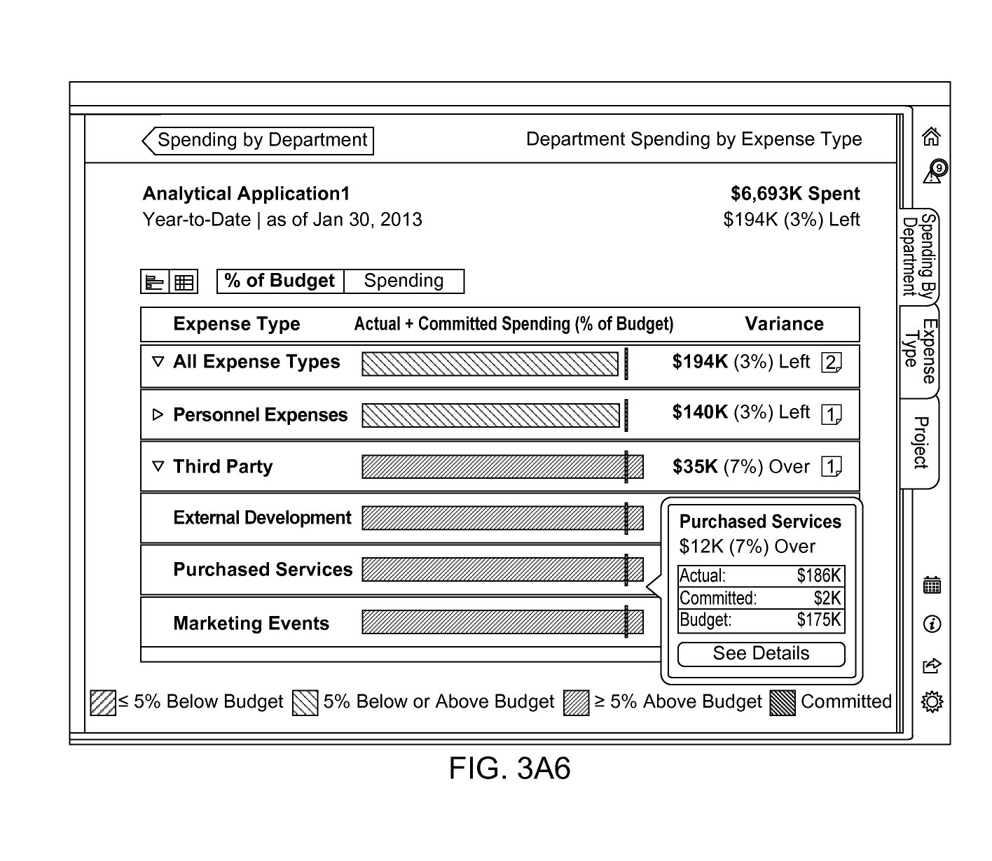

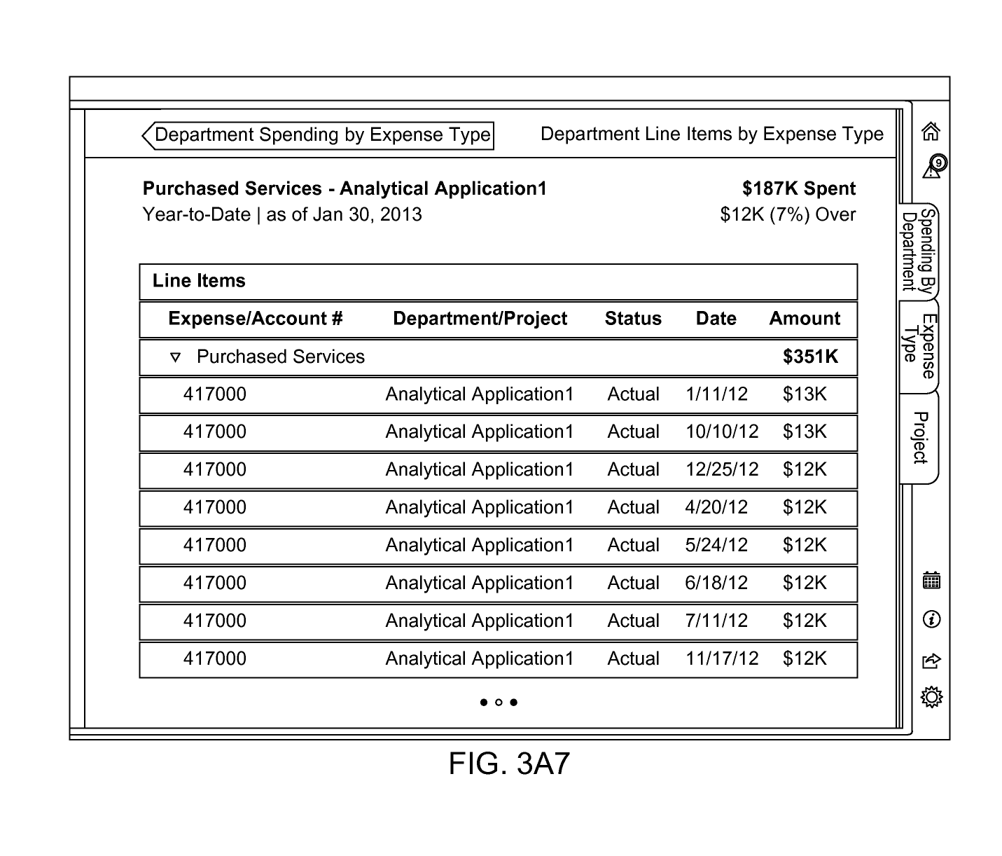

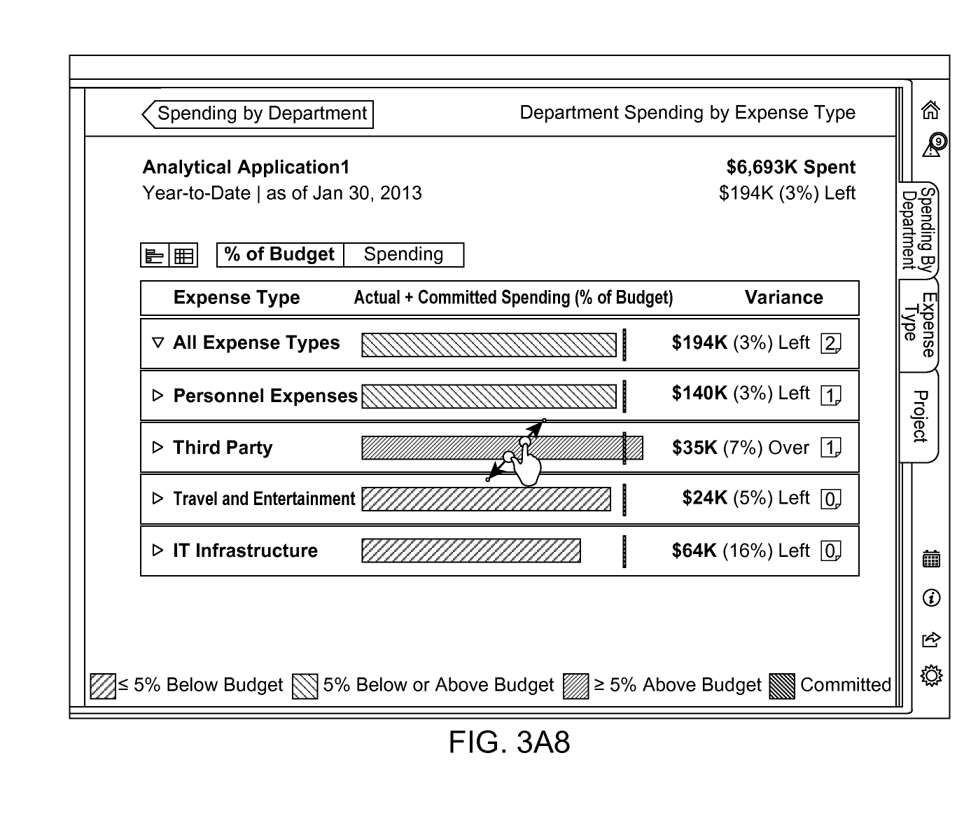

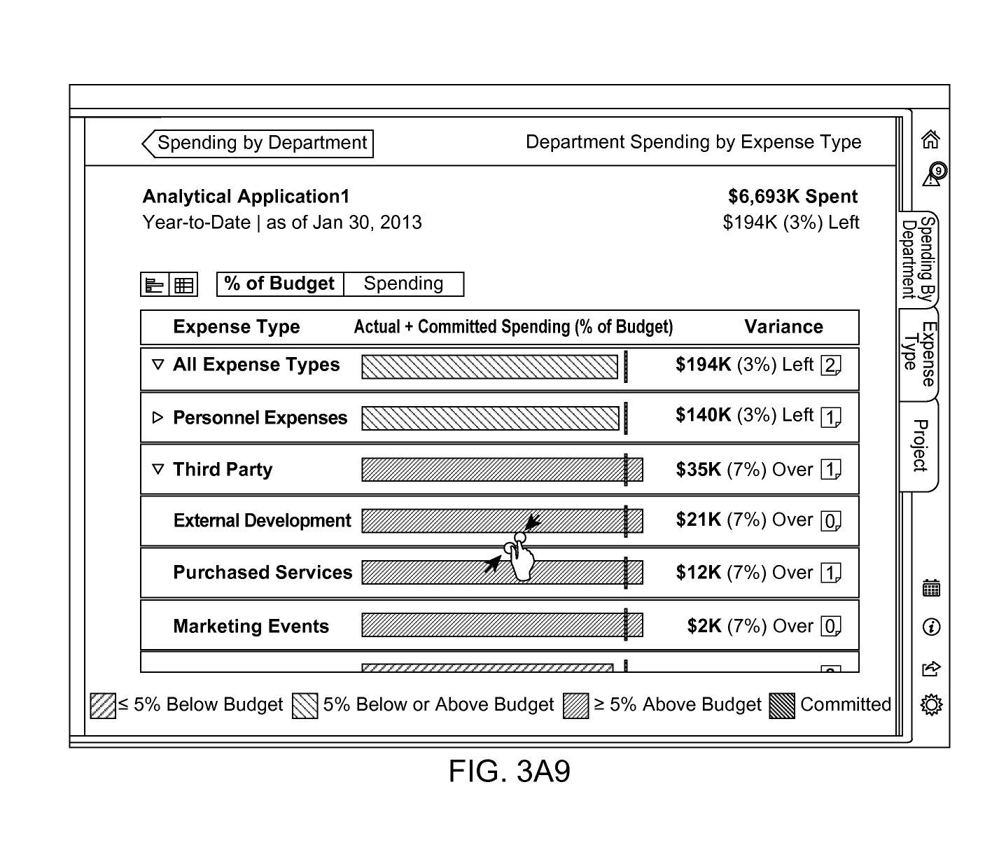

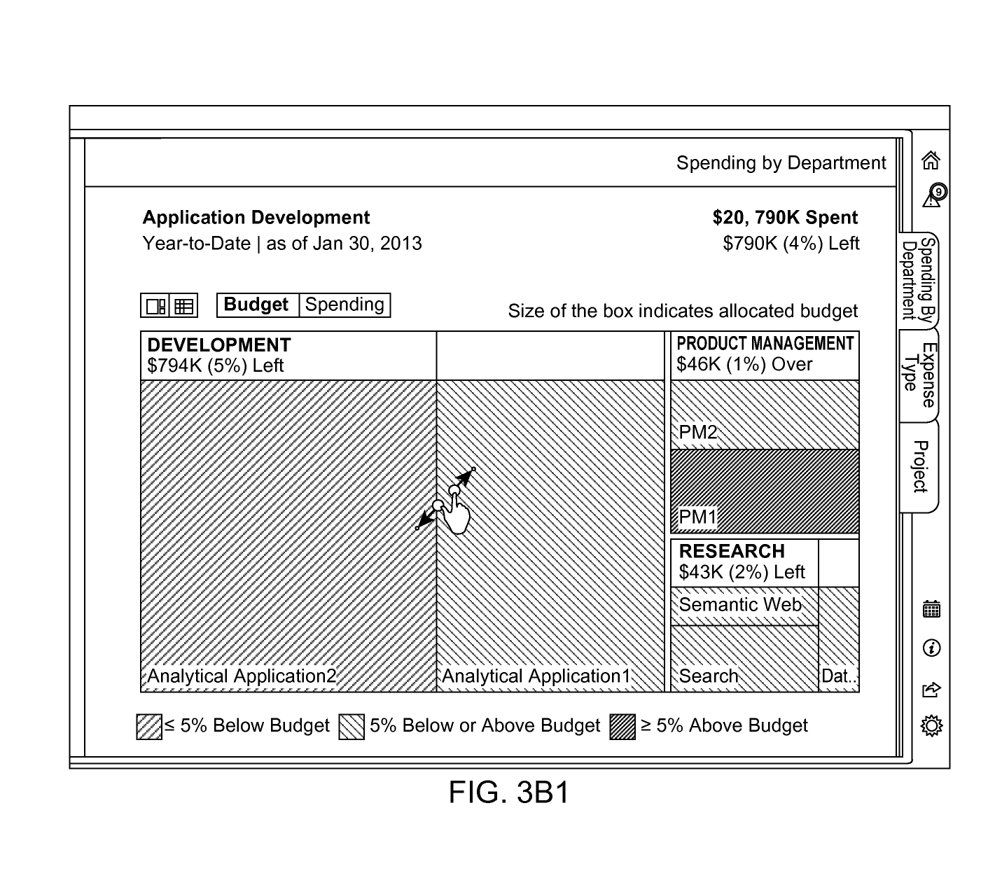

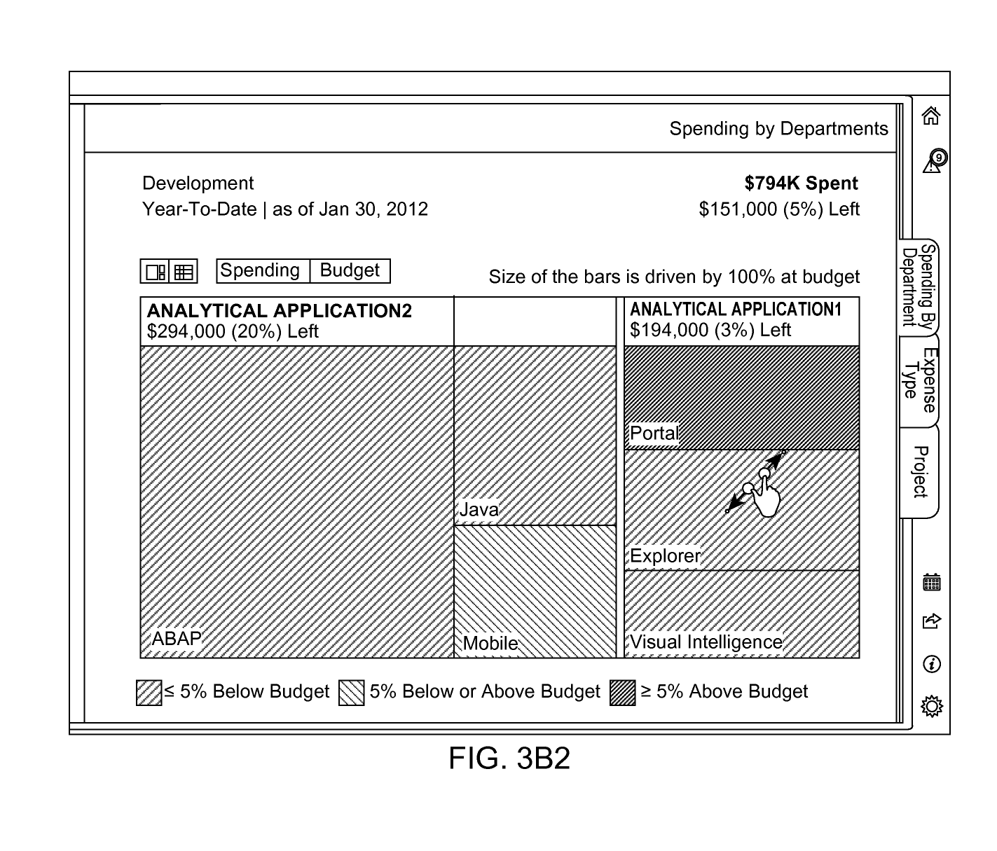

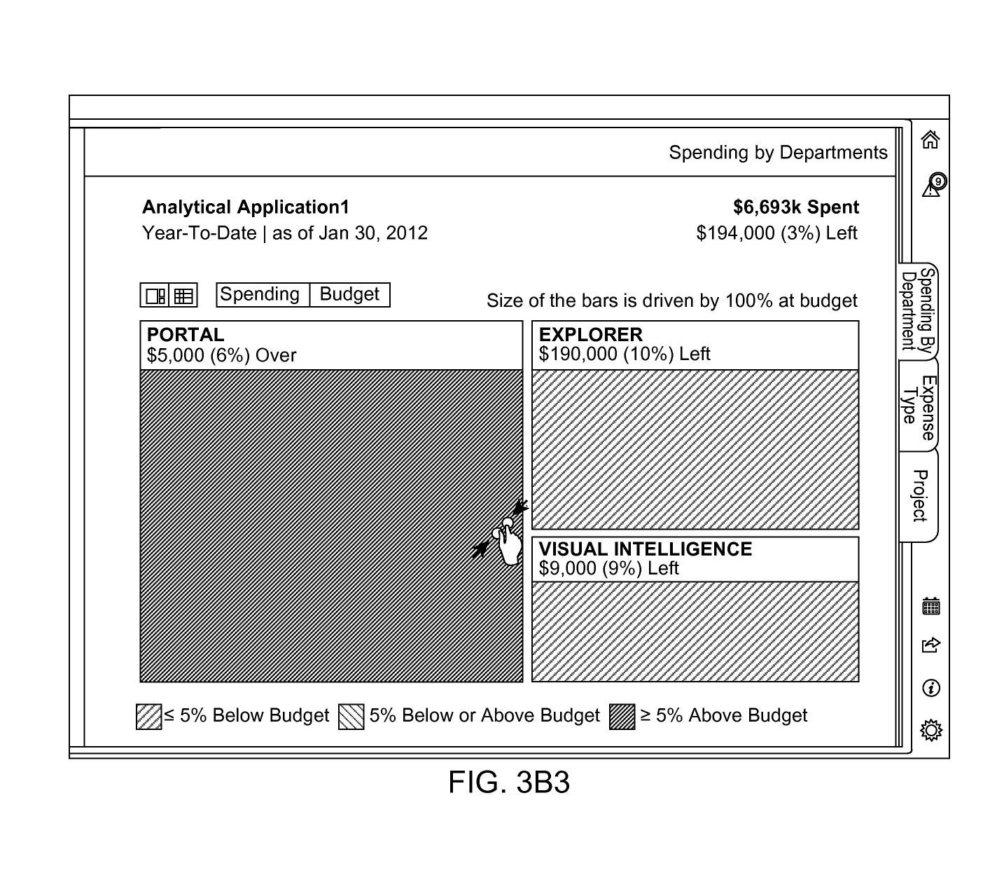

FIGS. 3-3B3 show screen shots of a specific example of a user interface according to an embodiment. FIG. 3 is a view of an initial interactive treemap, showing an amount of total spending (parent node) broken down by particular departments (child nodes), and within particular departments further broken down by various purposes (grandchild nodes). Colors of the various sub-areas indicate the status of spending relative to budget.

Based upon a user interaction of a first type (e.g., tapping a particular area on the screen), the interface may be caused to display spending details relating to that area (e.g., a relevant parent or child node). For example, FIG. 3A1 shows that based upon a user interaction of tapping the overlay for the DEVELOPMENT department parent node, the interface may be caused to display spending details relating to that particular department in the form of a pop up.

FIG. 3A2 shows accessing a detail screen for a child node. In particular, FIG. 3A2 shows that that based upon a user interaction of tapping the sub-area representing a child node (here.g., the Analytical Application1 project within the DEVELOPMENT department in FIG. 3A2), the interface may be caused to display spending details of that particular project in the form of a different pop up.

FIG. 3A3 shows that based upon another user interaction (e.g., tapping the “See Details” box of the pop-up of the child node), the interface may display a detail screen providing additional information in a form other than a treemap (e.g., a horizontal bar chart in FIG. 3A3).

FIG. 3A4 shows that the interface can be caused to display even more detail in the form of another pop-up by the user tapping on an element of the detail screen. This “See Details” button of the second pop-up allows the interface to provide a user with still further relevant details, including a breakdown into further nodes (e.g., “Purchased Services, “External Development”, and “Marketing Events”), as shown in FIG. 3A5.

Still further, forward navigation is possible. For example, FIG. 3A6 shows that additional detail can be provided in the form of another pop up screen by the user providing a particular type of input. FIG. 3A7 shows that by activating the “See Details” button of that pop-up, a user may navigate to access more detailed information in yet another format (e.g., line item).

Alternative or parallel forms of navigation within an interface are possible. FIG. 3A8 shows navigation by reverse finger pinching of the screen of FIG. 3A4, expanding a node and showing the detail screen of FIG. 3A5. FIG. 3A9 shows that by backward navigation by finger pinching, the user can return to the screen of FIG. 3A4.

In addition to showing details, the interactive user interface of FIG. 3 also allows navigation within the hierarchy of information. For example, FIG. 3B 1 shows a user providing input in the form of a reverse finger pinch on a specific sub-area of the first treemap screen of FIG. 3.

As a result of this input, the interface engine causes the interface to display a second treemap screen of FIG. 3B2, wherein the overall area represents the child node (“Development Department”), and the sub-areas represent various grandchild nodes (“Analytical Application1”, “Analytical Application2”). The treemap view of FIG. 3B2 also shows various great-grandchild nodes (“ABAP”, “JAVA”, “Portal” etc.) as further sub-areas, which were not visible in the original treemap of FIG. 3.

Still further downward navigation within the hierarchy is available, as shown by the reverse finger pinch input to the “ABAP” sub-area of the treemap of FIG. 3B2, resulting in display of the third treemap of FIG. 3B3. A finger pinch on that third treemap as shown can result in upward navigation through the hierarchy to cause the interface engine to return to displaying the second treemap of FIG. 3B2.

User interfaces according to various embodiments may offer certain benefits. For example, some embodiments may allow for the compact presentation of detailed information organized according to a hierarchical structure. Provision of interactive treemap views in combination with detail screens allows the user interface to present detailed information, while at the same time preserving the user's ability to intuitively recognize an overall hierarchical organization of data stored in a database.

One goal that may be accomplished by certain embodiments, is the ability to divide up the data for display, via multiple dimensions or attributes. For example, for a given dimension's value (e.g., Analytical Application1 for the “department” dimension), a user can move up and down the hierarchy for another dimension (e.g., Third Party or Purchased Services etc. for “expense type” dimension) in the detail screen. Then, a user can go back to the treemap and pick another value from the original dimension, again drilling down the alternate dimension in the detail screen. Such navigation is thus afforded to a user without having to put the hierarchies of both dimensions on the detail screen at the same time in a folder-like hierarchical structure appearing on the details screen. By avoiding the need to display multiple hierarchical structures at the same time, embodiments may make navigation within the interface more fluid and intuitive for the user.

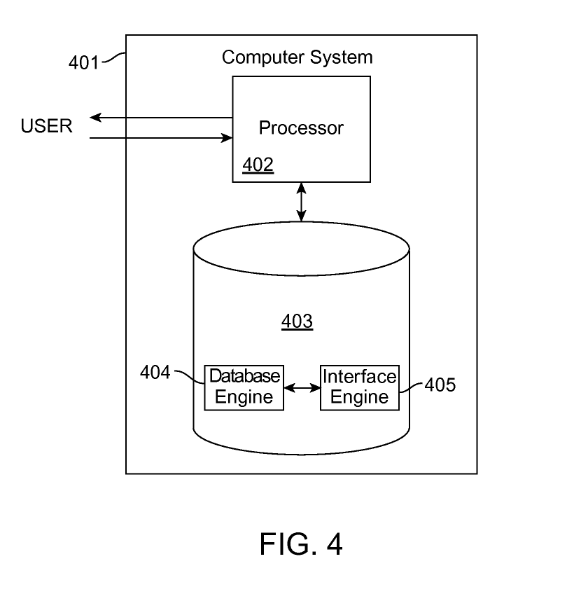

FIG. 4 illustrates hardware of a special purpose computing machine configured to implement a user interface according to an embodiment. In particular, computer system 400 comprises a processor 402 that is in electronic communication with a non-transitory computer-readable storage medium 403. This computer-readable storage medium has stored thereon code 405 corresponding to an interface engine. Code 404 corresponds to a database engine. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

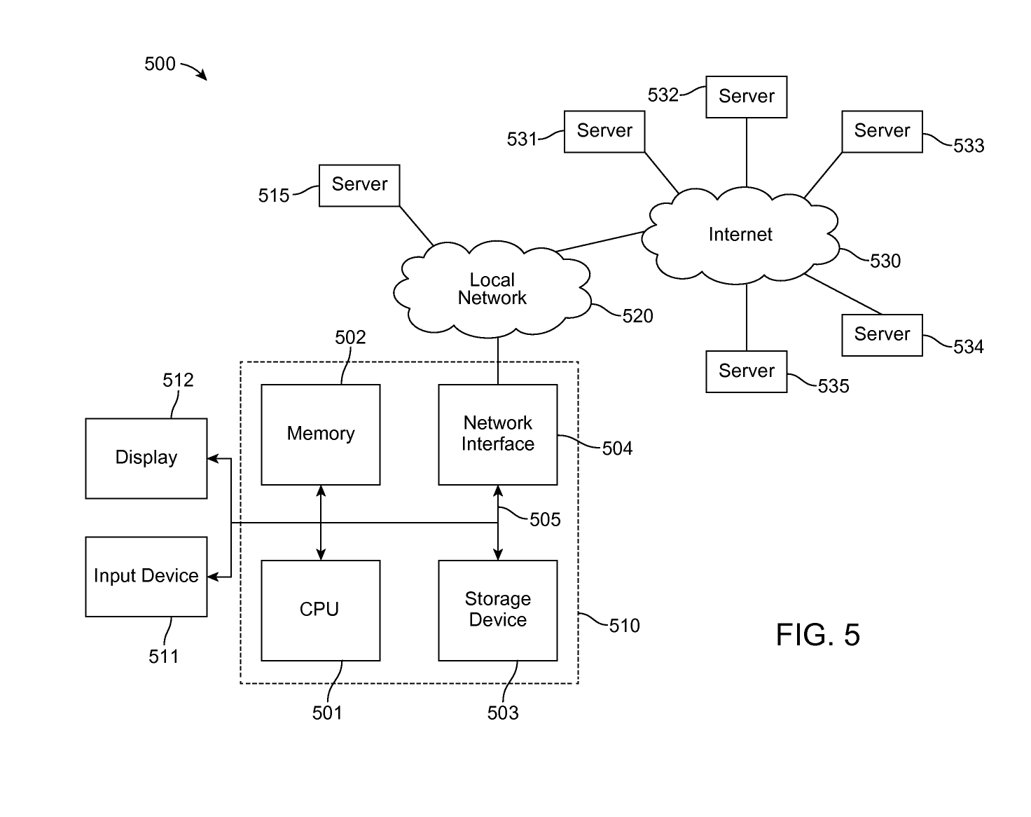

An example computer system 510 is illustrated in FIG. 5. Computer system 510 includes a bus 505 or other communication mechanism for communicating information, and a processor 501 coupled with bus 505 for processing information. Computer system 510 also includes a memory 502 coupled to bus 505 for storing information and instructions to be executed by processor 501, including information and instructions for performing the techniques described above, for example. This memory may also be used for storing variables or other intermediate information during execution of instructions to be executed by processor 501. Possible implementations of this memory may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 503 may include source code, binary code, or software files for performing the techniques above, for example. Storage device and memory are both examples of computer readable mediums.

Computer system 510 may be coupled via bus 505 to a display 512, such as a cathode ray tube (CRT) or liquid crystal display (LCD), for displaying information to a computer user. An input device 511 such as a keyboard and/or mouse is coupled to bus 505 for communicating information and command selections from the user to processor 501. The combination of these components allows the user to communicate with the system. In some systems, bus 505 may be divided into multiple specialized buses.

Computer system 510 also includes a network interface 504 coupled with bus 505. Network interface 504 may provide two-way data communication between computer system 510 and the local network 520. The network interface 504 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 604 sends and receives electrical, electromagnetic, or optical signals that carry digital data streams representing various types of information.

Computer system 510 can send and receive information, including messages or other interface actions, through the network interface 504 across a local network 520, an Intranet, or the Internet 530. For a local network, computer system 510 may communicate with a plurality of other computer machines, such as server 515. Accordingly, computer system 510 and server computer systems represented by server 515 may form a cloud computing network, which may be programmed with processes described herein. In the Internet example, software components or services may reside on multiple different computer systems 510 or servers 531-535 across the network. The processes described above may be implemented on one or more servers, for example. A server 531 may transmit actions or messages from one component, through Internet 530, local network 520, and network interface 504 to a component on computer system 510. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
providing a database storing information according to a hierarchy comprising a parent node and a child node;
causing an interface engine to display a first interactive treemap comprising a first overall area representing the parent node and comprising the child node as a first sub-area of the first overall area;
causing the interface engine to receive user input;
in response to the user input, causing the interface engine to display a detail of the child node or of the parent node.

2. A method as in claim 1, wherein the interface engine is caused to display the detail as a pop-over of the treemap.

3. A method as in claim 1, wherein the interface engine is caused to display the detail as a separate detail screen.

4. A method as in claim 1, wherein the interface is caused to display the detail as a second interactive treemap comprising a second overall area representing the child node and comprising a grandchild node of the hierarchy as a sub-area of the second overall area.

5. A method as in claim 1, wherein the first interactive treemap is displayed on a touchscreen and the user input comprises touching the touch screen.

6. A method as in claim 1, wherein the interface engine is located in a user device.

7. A method as in claim 1, wherein the interface engine is located remote from a user device.

8. A non-transitory computer readable storage medium embodying a computer program for performing a method, said method comprising:
providing a database storing information according to a hierarchy comprising a parent node and a child node;
causing an interface engine to display a first interactive treemap comprising a first overall area representing the parent node and comprising the child node as a first sub-area of the first overall area;
causing the interface engine to receive user input;
in response to the user input, causing the interface engine to display a detail of the child node or of the parent node.

9. A non-transitory computer readable storage medium as in claim 8, wherein the interface engine is caused to display the detail as a pop-over of the treemap.

10. A non-transitory computer readable storage medium as in claim 8, wherein the interface engine is caused to display the detail as a separate detail screen.

11. A non-transitory computer readable storage medium as in claim 8, wherein the interface is caused to display the detail as a second interactive treemap comprising a second overall area representing the child node and comprising a grandchild node of the hierarchy as a sub-area of the second overall area.

12. A non-transitory computer readable storage medium as in claim 8, wherein the first interactive treemap is displayed on a touchscreen and the user input comprises touching the touch screen.

13. A non-transitory computer readable storage medium as in claim 8, wherein the interface engine is located in a user device.

14. A non-transitory computer readable storage medium as in claim 8, wherein the interface engine is located remote from a user device.

15. A computer system comprising:
one or more processors;
a software program, executable on said computer system, the software program configured to:
provide a database storing information according to a hierarchy comprising a parent node and a child node;
cause an interface engine to display a first interactive treemap comprising a first overall area representing the parent node and comprising the child node as a first sub-area of the first overall area;
cause the interface engine to receive user input;
in response to the user input, cause the interface engine to display a detail of the child node or of the parent node.

16. A computer system as in claim 15, wherein the interface engine is caused to display the detail as a pop-over of the treemap.

17. A computer system as in claim 15, wherein the interface engine is caused to display the detail as a separate detail screen.

18. A computer system as in claim 15, wherein the interface is caused to display the detail as a second interactive treemap comprising a second overall area representing the child node and comprising a grandchild node of the hierarchy as a sub-area of the second overall area.

19. A computer system as in claim 15, wherein the first interactive treemap is displayed on a touchscreen and the user input comprises touching the touch screen.

20. A computer system as in claim 15, wherein the interface engine is located in a user device or is located remote from a user device.
